(19) United States
(12) Patent Application Publication
(10) Pub. No.: US 2012/0235438 A1
(43) Pub. Date: Sep. 20, 2012

(54) ANTI-SLIP INSERT MAT AND METHOD FOR PRODUCING SAID INSERT MAT

(75) Inventors: Hubert Röding, Ebrach (DE); Björn Fischer, Berlin (DE)

(73) Assignee: IDEAL AUTOMOTIVE GMBH BAMBERG, Bamberg (DE)

(21) Appl. No.: 13/395,163

(22) PCT Filed: Aug. 27, 2010
(86) PCT No.: PCT/EP10/62581

§ 371 Date: May 29, 2012

(30) Foreign Application Priority Data
Sep. 9, 2009 (DE) 10 2009 040 761.8

(51) Int. Cl. B60N 3/04; D06C 15/00; D06C 7/00; D06C 13/08; D04H 1/46

(52) U.S. Cl. 296/97.23; 28/161; 28/108; 28/122; 28/165

(57) ABSTRACT

The invention relates to an anti-slip insert mat having a carrier layer and a textile catching layer formed of filaments/fibers, wherein the catching layer has raised regions and compressed regions of lower height, wherein the raised regions are formed by free ends of the fibers and the compressed regions of the catching layer are formed by permanently pressing the free ends of the fibers.

### FIELD OF THE INVENTION

The invention relates to an anti-slip insert mat and a method for producing said insert mat.

### BACKGROUND OF THE INVENTION

Known insert mats for inserting into footwells of motor vehicles, in particular passenger vehicles with built-in carpeted floor pans, have essentially the following design.

A use/decorative surface is tufted into a backing layer and in most cases, is embodied as a cut pile surface, i.e. with the tufting loops cut open. A nonwoven is situated on the side of the backing layer oriented away from the decorative side and is bonded to the entire surface of the backing layer. In order to achieve a sufficient adhesion of the insert mat to the carpeted floor pan of the passenger vehicle, it is common for subregions of the free surface of the nonwoven to be flocked with short fibers so as to produce adhesion islands. Flocking subregions of the free surface of the nonwoven is extremely complicated and expensive. For example, after the attachment of the nonwoven layer, first the flocking fibers must be attached to the felt in defined locations. Then electrostatic charging procedures must be used to erect the fibers so that they stand up from the nonwoven as perpendicularly as possible. Then, the erected fibers must be permanently attached in the erected position. Although an insert mat of this kind can in fact fulfill the currently general requirements with regard to the adhesion force of the insert mat to the floor, i.e. to the cut pile of the carpeted floor pan of the passenger vehicle, this takes a significant amount of effort. On the other hand, for example due to soiling of the underside of the insert mat, the hooking islands composed of the short, relatively fine fibers from the flocking procedure can over time lose the force of adhesion to the cut pile of the carpeted floor pan of the motor vehicle. The reason for this is that the fibers of the flocked islands are spaced relatively close to one another and essentially are all the same length. This makes it easier for dust and dirt to become embedded during use of the insert mat, which results in a reduction of the adhesiveness of the insert mat to the carpeted floor of the motor vehicle. Even if the adhesion islands that are produced by flocking are cleaned at conventional carwashes, for example with two brush rollers, this does not always succeed to a satisfactory degree since the dirt and dust gets trapped rather stubbornly between the fibers of the flocked islands.

DE 10 2005 025 681 A1 has disclosed a single-layer piece of interior carpeting for motor vehicles, which has a backing layer and a decorative layer in which the decorative layer is tufted into the backing layer. On the side opposite from the decorative layer, there is an underlayer that is tufted into this same backing layer. The underlayer is composed of cut yarn loops and the free ends of the pile yarn hook into the underlying support of the single-layer piece of interior carpeting. Although this single-layer piece of interior carpeting has in fact proven successful, the requirements for adhesiveness of insert mats are always increasing, thus making it necessary to increase the static friction or adhesive force of the insert mat to its underlying support.

WO 2004/050347 A1 has disclosed a textured composite material made from at least an outer layer composed of fibers and an adhesive layer. These layers are treated so as to produce higher and lower regions. A flat backing layer can be optionally provided on its side oriented toward the floor. The composite material disclosed in this reference also does not fulfill the requirements for a high level of static friction and adhesive force.

The object of the present invention, therefore, is to disclose an anti-slip insert mat that on the one hand, meets increased requirements for adhesiveness to a carpeted floor of a passenger vehicle, in particular a cut pile carpet, i.e. a carpet whose top surface does not have any loops.

The present invention should also disclose an insert mat and a method for producing the insert mat, which are less expensive, simpler, and less complex to carry out than known insert mats and/or methods.

The present invention should also disclose an insert mat that can be easily cleansed of the soiling that inevitably occurs with use and can be restored by said cleaning to the original adhesion force that it had when new.

### SUMMARY OF THE INVENTION

The invention is based on the realization that an insert mat of this generic type, with a primary backing as a backing layer for a decorative layer and a textile hooking layer composed of fibers is improved by the fact that the hooking layer has raised regions and compacted regions of lower height, with the raised regions being composed of free ends of the fibers and the hooking layer regions of lower height, i.e. the compacted regions, being produced by permanent compression of the free ends of the fibers. An insert mat of this kind according to the invention is particularly inexpensive to produce since free ends of the textile layer comprising the hooking layer are used to hook into a carpeted floor of a motor vehicle. The compression in some regions of the textile layer comprising the hooking layer produces raised regions and compressed regions of a lower height, i.e. in these regions, the textile layer comprising the hooking layer has a reduced thickness. This successfully brings the protruding fibers of the raised regions into a more intensive contact with the carpeted floor lining of the motor vehicle. This produces an increased degree of hooking so that even with low compressive loads exerted on the insert mat, a sufficient degree of hooking and therefore a good force of adhesion to the carpeted floor layer of the passenger vehicle can be achieved.

According to a particularly preferred embodiment, the hooking layer is composed of a tuft with a backing layer and a pile yarn that is tufted into the backing layer. The raised regions are composed of the free ends of the pile yarn, which are cut during or after the tufting. The hooking layer regions with the lower height are produced by permanently compressing the free ends of the pile yarn. In this embodiment, the pile yarn is preferably embodied in the form of a multifilament around which at least one monofilament is wound; the monofilament is embodied as thicker than the filaments composing the multifilament.

The thicker monofilament is wound helically or in a spiral shape around the multifilament and together with the multifilament, composes a yarn used for the tufting process. Since the pile loops formed during the tufting process are cut open to produce free pile yarn ends, in the region of the free ends of the pile yarn, the thicker monofilament can loosen and/or unwind at least a little from the multifilament. The unwound/loosened end of the monofilament, due to the previous winding of the multifilament, is somewhat longer than the free ends of the multifilament. Furthermore, the free ends of the monofilament are somewhat stiffer and more buckling-resistant than the free ends of the fibers of the multifilament. As a result, the longer, farther-protruding ends of the monofilament can penetrate deep into the carpet structure of the carpeted floor of the passenger vehicle and thus produce a particularly secure hooking and a particularly durable adhesion of the insert mat to prevent it from slipping off.

According to another embodiment of the insert mat according to the invention, the hooking layer is composed of a velourized needle punched nonwoven. This layer composed of a velourized needle punched nonwoven can be mounted in a particularly inexpensive fashion since the nonwoven layer can be bonded to the entire surface, for example of the backing layer of the decorative layer. In particular, it is possible to use fibers made of PET, PP, PA6, or PA6.6 for the fibers of the velourized needle punched nonwoven. A weight per unit area of the velourized needle punched nonwoven of 200 g/m² to 800 g/m² has turned out to be particularly advantageous. The fibers of the velourized needle punched nonwoven preferably have a fineness of 20 dtex to 100 dtex and have a cut length of 30 mm to 80 mm. The velourized needle punched nonwoven can preferably be used as a clipped needle punched nonwoven. Furthermore, the velourized needle punched nonwoven can be composed of a fiber mix of different finenesses or different cut lengths.

It is likewise possible to use fibers composed of different materials such as a mix of PP and PA fibers.

It has turned out to be particularly advantageous that the raised regions on the underside of the insert mat form islands. This succeeds in producing selected areas with an increased degree of hooking between the insert mat and the underlying carpeted floor of the passenger vehicle.

It has turned out to be equally advantageous that the raised regions have a contiguous linear pattern, in particular one that is contiguous over the entire area of the insert mat. For the projection of the raised regions compared to the compressed regions of the hooking layer, dimensions of 0.5 mm to 3 mm, preferably from 1 mm to 2 mm, have turned out to be advantageous. Within these ranges, the free ends of the fibers composing the raised regions still have enough inherent stiffness to reliably ensure penetration into the surface of the underlying passenger vehicle carpet.

The permanently compressed regions are preferably produced by means of thermal compression that fuses the filaments of the multifilament and the winding monofilament to one another at least in some regions and/or the filaments and the monofilaments are at least partially fused to the backing layer of the decorative layer or to the backing layer of the hooking layer. This produces a sufficient permanence of the compression and thus a permanent formation of the underside relief of the insert mat to be implemented according to the invention. As a preferable ratio between the thickness of the monofilament on the one hand and the filaments that compose the multifilament on the other, it has turned out to be advantageous to embody the monofilament as approximately two to ten times, preferably five to twenty times thicker. In particular, fibers composed of PA6, PA12, PP, or PET can be used for the multifilament and monofilament.

In order to further improve the slip resistance of the insert mat on the carpeted floor of the passenger vehicle, it is advisable to position the raised regions closer together in regions of the insert mat that are subjected to greater stepping pressure or compressive load during use than they are in regions that are subjected to less stepping pressure or compressive load. In regions that are subjected to greater compressive load, i.e. in the regions in which the occupants are more likely to place their feet on the insert mat, there is a greater load per unit area during use, which causes the free fiber ends to hook into the passenger vehicle carpet. In these regions, the area percentage of the raised regions can be selected to be greater than the area percentage of the compressed regions. The degree of compression of the regions that are recessed relative to the raised regions can also be selected to be somewhat less in regions that are subjected to greater stepping pressure or compressive load. In comparison to a greater compression, this produces more free fiber ends that are not integrated or are not totally integrated into the pressure bond and therefore even in the compressed regions, possibly contribute to the additional hooking of the insert mat into the carpeted floor of the passenger vehicle.

In order to further improve the hooking and therefore the slip resistance of the insert mat, in the region that is subjected to greater stepping pressure or compressive load, it is also advantageous to select the size in area of the raised regions to be greater per unit area of the insert mat to be greater than it is in the region that is subjected to less stepping pressure or compressive load.

The raised regions are preferably embodied in the form of circular, annular, oval, triangular, polygonal, or irregularly shaped island contours. With closed linear patterns, a honeycomb-like linear pattern has turned out to be particularly advantageous.

It has turned out to be particularly advantageous that at least two monofilaments are wound around the multifilament in a manner that resembles a two-threaded or multi-threaded screw. This increases the number of longer free ends of monofilament per unit area, which results in an improved slip resistance. An equivalent effect of improved slip resistance can be achieved if two monofilaments are twisted to form a winding multifilament and the winding multifilament is wound in a helix around the multifilament of the pile yarn.

It is also possible for several winding multifilaments to be wound around a multifilament of the pile yarn. An embodiment of this kind produces a multitude of longer, protruding free ends of the monofilament, which can favorably hook into the structure of the passenger vehicle carpet.

It has also been possible to determine that with a given weight load of the insert mat, the slip resistance of the insert mat is optimal if the area percentage of the raised regions is less than or at most equal to the area percentage of the compressed regions of the insert mat.

A method according to the invention in particular features the fact that first, a hooking layer is mounted onto a backing layer of a decorative layer, which hooking layer is locally compressed in a permanent fashion at least in some regions, producing raised regions with free fibers and compressed regions of a lower height. According to a first alternative, a dilour needle punched nonwoven layer is used as the hooking layer and the compression is produced through the use of heat or ultrasound. According to a second alternative of the method according to the invention, the hooking layer is produced on at least one side of the backing layer by tufting a pile yarn into a backing layer of the hooking layer, with a yarn composed of a multifilament being used as the pile yarn and with the tufted pile yarn being cut so that free pile ends are produced. Then the free pile ends are compressed in some subregions and/or permanently compacted so that raised regions of the hooking layer are produced, which are composed of pile ends. For the compression in some regions and/or permanent compaction, it has turned out to be advantageous to use a pressing by means of a heated pressing template that exempts the raised regions from the compressing action. As a result of this, in the compressed regions, the fibers that compose the hooking layer are at least partially fused to one another and thus permanently compressed. It is also suitable to produce the compression and/or permanent compaction by using ultrasound, which in combination with a pressing template, produces a permanent connection of the fibers in the compressed regions.

Preferably, a yarn composed of a multifilament and at least one monofilament wound around the multifilament is used for the pile yarn. The monofilament is embodied as thicker than the fibers/filaments of which the multifilament is composed.

Other advantageous embodiments, both with regard to the method and with regard to the insert mat, are disclosed in additional dependent claims.

Examples of the invention will be described in greater detail below in conjunction with the drawings.

### BRIEF DESCRIPTION OF THE DRAWINGS

FIG. 1 shows a very schematic cross-section through a first alternative of the insert mat according to the invention.

FIG. 2 shows a very schematic cross-section through a second alternative of the insert mat according to the invention.

FIG. 3 shows a detail X from FIG. 1.

FIG. 4 shows a (very schematic) enlarged depiction of a pile yarn for forming the insert mat according to FIGS. 2 through 3.

FIG. 5 shows another embodiment of the insert mat according to the invention, with circular adhesion islands.

FIG. 6 shows another embodiment of the insert mat according to the invention, with annular adhesion islands.

FIG. 7 shows another embodiment of the insert mat according to the invention, with hexagonal adhesion islands.

FIG. 8 shows another embodiment of the insert mat according to the invention, with adhesion regions in the form of closed continuous lines/linear patterns.

FIG. 9 shows the insert mat according to the invention, with adhesion regions in the form of a closed honeycomb pattern.

FIG. 10 shows another embodiment of the insert mat according to the invention, with adhesion islands distributed nonuniformly over the adhesion surface of the insert mat, i.e. the underside of the insert mat.

### DETAILED DESCRIPTION OF THE PREFERRED EMBODIMENTS

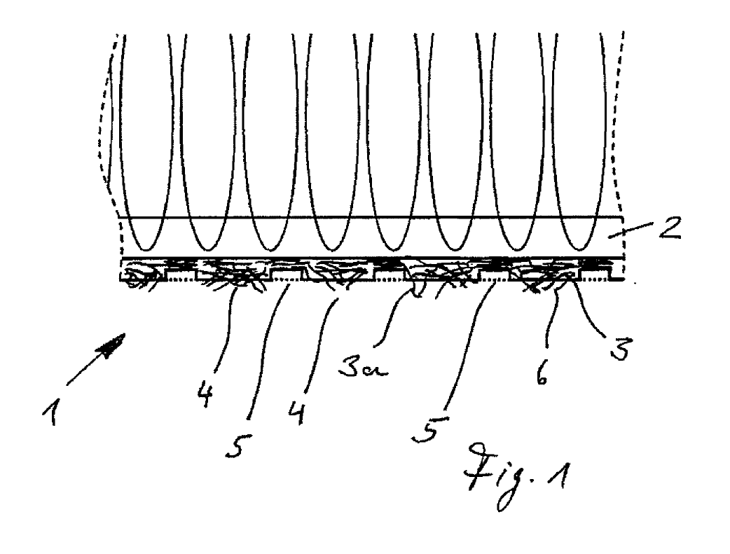

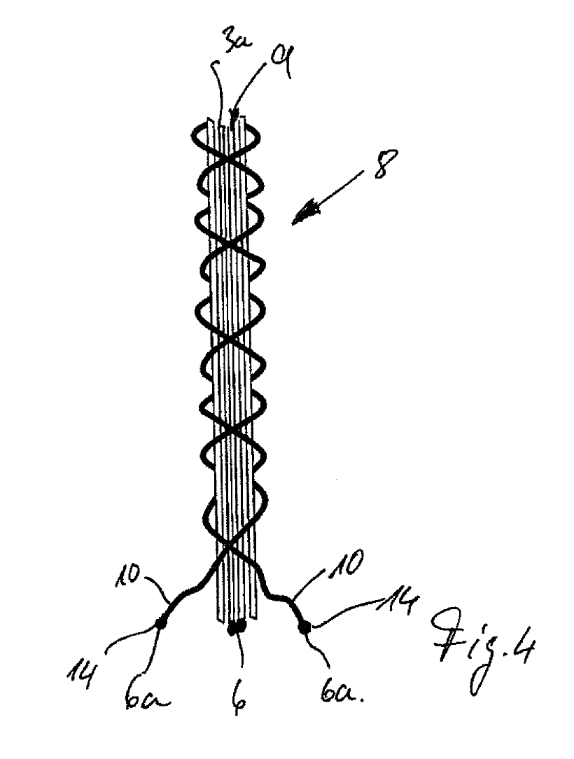

A first exemplary embodiment of the insert mat 1 according to the invention (FIG. 1) has a primary backing as a backing layer 2 for a decorative layer 15. A hooking layer 3 is attached to the underside of the backing layer 2 by means of a bonding layer (not shown in FIG. 1). The hooking layer 3 is composed of fibers 3a. The hooking layer has raised regions 4 and compacted regions 5. Irregular free ends 6 of the fibers 3a composing the hooking layer 3 protrude in the region of the raised regions 4. In the exemplary embodiment according to the invention shown in FIG. 1, the hooking layer is a velourized needle punched nonwoven with a weight per unit area of approx. 200 g/m² up to 800 g/m². The fibers 3a of the velourized needle punched nonwoven have a fineness of 20 dtex to 100 dtex and a cut length of 30 mm to 80 mm. The velourized needle punched nonwoven is preferably clipped, but can also be unclipped when there are reduced requirements with regard to the adhesion force. The raised regions 4 can be embodied, for example, in the form of islands 11 or in the form of a closed linear pattern 11a, which will be explained in greater detail below in conjunction with FIGS. 5 through 9.

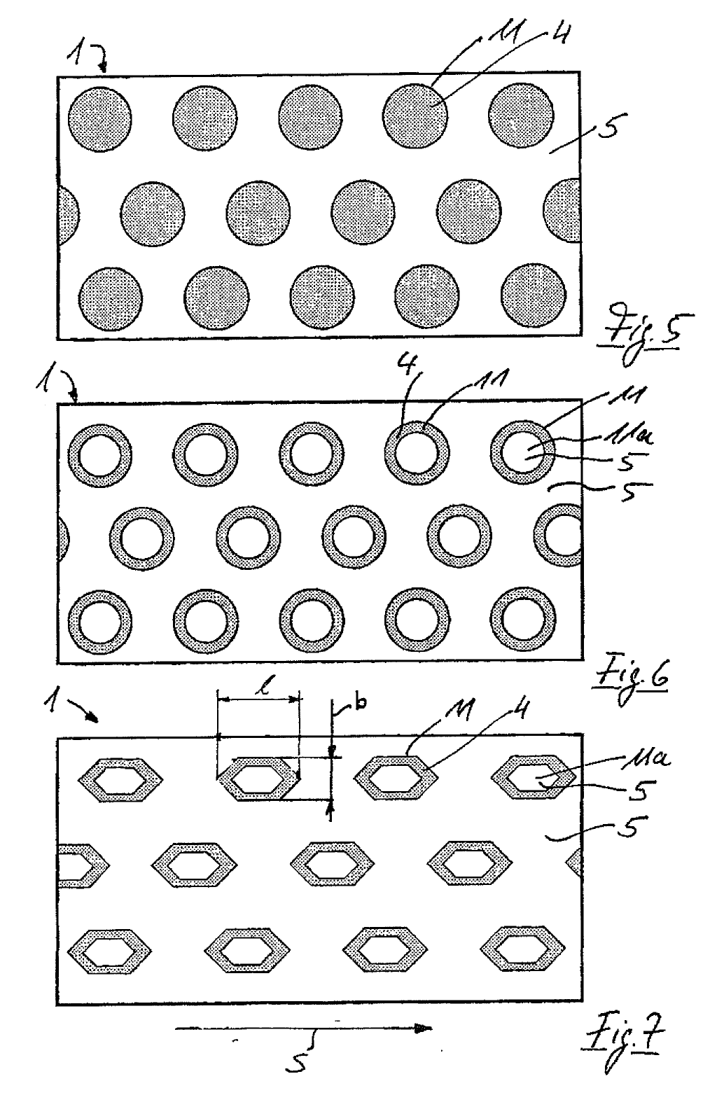

The islands 11 (FIGS. 5 through 7) can be distributed in either a regular circular area pattern or irregularly over the area of the insert mat 1. In an embodiment according to FIG. 6, the islands 11 are annular, with a center region 11b likewise comprised by a compacted region 5.

In an embodiment according to FIG. 7, the spatial shape of the islands 11 is depicted for example in the form of a hexagon with a center region 11b. In this exemplary embodiment, the length l of the islands 11 is greater than the width b of the islands 11. If island shapes are selected that have a length l that is greater than the width b, then it is advisable to orient their length l parallel to a pile direction S of an underlying support 30 onto which the insert mat 1 is to be placed in proper use. This successfully achieves an improved hooking of the insert mats 1 to the underlying support 30.

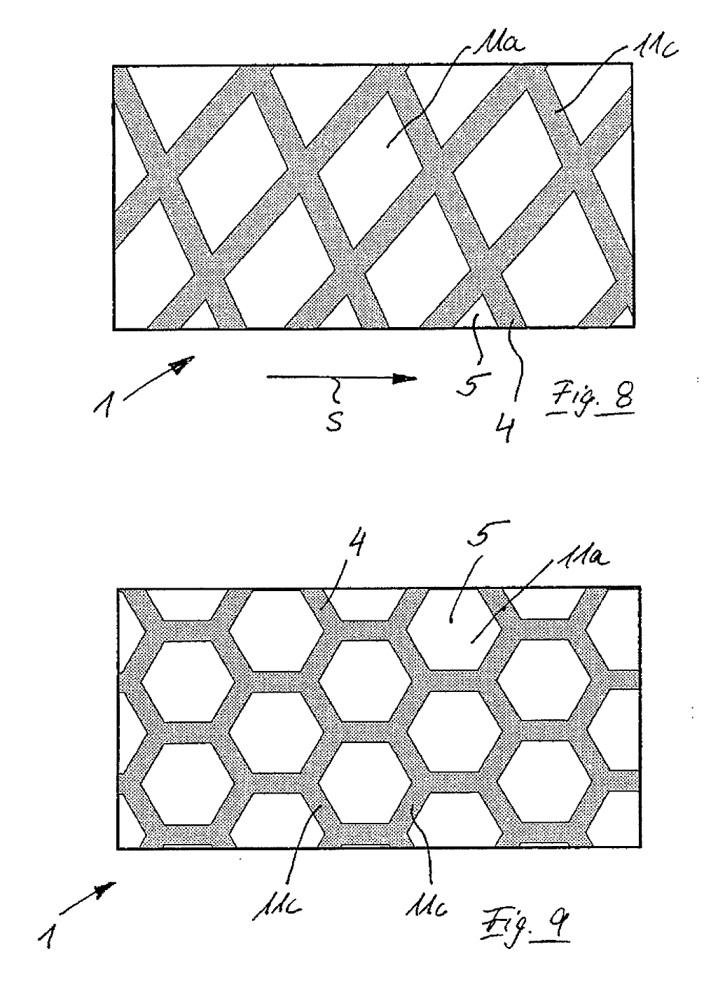

In an embodiment according to FIG. 8, the raised regions 4 are arranged in the form of a closed linear pattern distributed over the underside of the insert mat 1. In the context of the invention, the expression “closed linear pattern” is understood to mean a linear pattern in which all of the raised regions 4 of the insert mat 1 are connected to one another. This differentiates the closed linear pattern from the above-described arrangement of islands 1 on the underside of the insert mat 1. Naturally, it is also possible to provide subregions of the insert mat 1 with a closed linear pattern and remaining regions of the insert mat 1 with island-shaped raised regions 4. The island patterns and linear patterns depicted in FIGS. 5 through 9 are to be understood merely as examples. Naturally, other geometrical shapes can be provided, such as ovals or ovals with center regions 11a or closed linear patterns 11a, with connecting lines that are not straight or with connecting lines that are distributed irregularly over the underside of the insert mat 1. In an embodiment of the insert mat 1 according to the invention with a closed linear pattern 11a as shown by way of example in FIG. 8, it is advisable to permit at least subregions of lines 11c that form the closed linear pattern to extend obliquely to a pile direction S of an underlying support onto which the insert mat is to be placed in proper use, i.e. not absolutely at an angle of 90° or parallel to the direction S. This gives the insert mat an increased adhesion capacity. For example, in motor vehicles, it is standard for the pile direction S of the passenger vehicle carpet (not shown) to be oriented toward the rear in the direction of travel, parallel to the longitudinal axis of the vehicle.

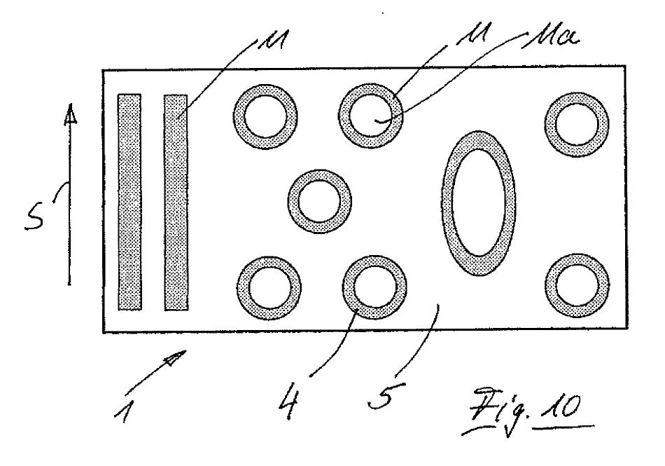

FIG. 9 shows a particularly preferred exemplary embodiment of the insert mat according to the invention in which the raised regions 4 are embodied as a closed linear pattern in the form of a hexagonal honeycomb structure. Tests have shown that the adhesion force of such a linear pattern for the raised regions 4 has the maximum static friction values on an underlying support 30 in comparison to other embodiments of linear patterns.

In an embodiment according to FIG. 10, different geometrical embodiments of islands 11 are arranged distributed in different areal densities over the underside of the insert mat 1.

In regions in which a greater stepping pressure or compressive load during use is expected, for example in a region in which it is more probable for the occupants to place their feet, it is particularly advantageous to place the raised regions closer together than they are in regions with less stepping pressure or compressive load during use. For example, one region that is subjected to less compressive load or stepping pressure during use is the region of an insert mat 1 that is positioned in a rear footwell of a passenger vehicle and protrudes a certain distance under the seat bottom of the front seat. In this region, only slight compressive loads or stepping pressures can occur during use so that it is suitable to provide raised regions distributed at a lower density over the surface so that these can favorably hook into the insert mat 1 with less of a load, in particular by virtue of their own weight.

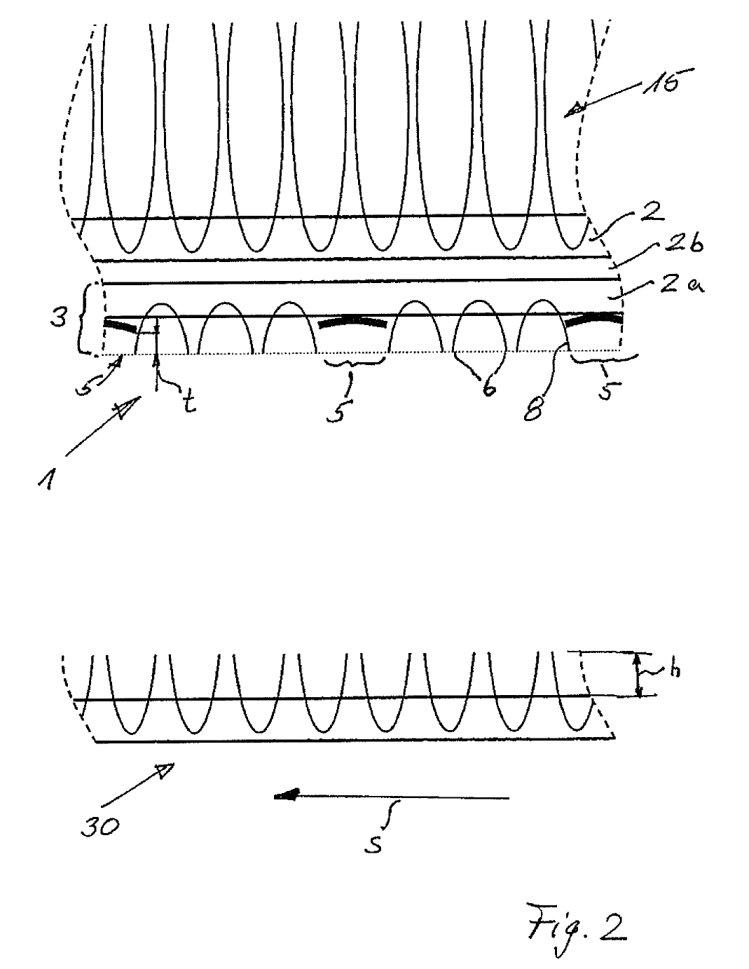

A second alternative of the insert mat according to the invention will be explained in greater detail below in conjunction with FIGS. 2 through 4.

The insert mat 1 according to the invention has a backing layer 2 as a primary backing for a decorative layer 15 composed of a tuft. The hooking layer 3 is situated on an underside of the backing layer 2. The pile loops are cut to produce the free ends 6 of pile yarn 8. Subregions of the hooking layer 3 are permanently compacted and/or compressed regions 5, leaving remaining raised regions 4. The decorative layer 15 is embodied, for example, as cut pile, with the cut loops that compose the cut pile being tufted into the backing layer 2. The free ends 6 of the pile yarn 8 of the hooking layer 3 project from the backing layer 2a, forming hooking devices for engaging with an underlying support 30, which can for example be a passenger vehicle carpet that in most cases is also a tuft. The underlying support 30 usually has a pile direction S that is often oriented in the direction of a longitudinal axis of a passenger vehicle, toward the rear in the direction of travel. The compacted regions 5 are produced by permanently compressing free ends 6 of the pile yarn 8 and are shorter in their vertical length, viewed from the backing layer 2, than the raised regions 4, which have a greater vertical length extending away from the backing layer 2.

It has turned out to be advantageous to permit the raised regions 4 to project by approx. 0.5 mm to 3 mm, preferably by 1 mm to 2 mm, beyond the compacted regions 5. In order to achieve this, either the degree of compaction can be varied or the length of the free ends 6 at a given degree of compaction for the compacted regions 5 can be appropriately set. This essentially depends on the structure of the underlying support 30. It is therefore advisable to keep the free ends 6 particularly short, for example with a particularly shallow-pile passenger vehicle carpet (underlying support 30). For logical reasons, the length of the free ends 6 or the projection t of the raised regions 4 relative to the compacted regions 5, for example, should not be selected to be greater than the pile height h of the underlying support 30. The degree of compaction for producing the compacted regions must be appropriately selected to achieve an appropriate projection t between the raised regions 4 and the compacted regions 5.

With deep-pile underlying supports, the degree of compaction can be selected to be somewhat less and a corresponding projection t of the raised regions 4 relative to the compacted regions 5 can be achieved with a greater length of the free ends 6.

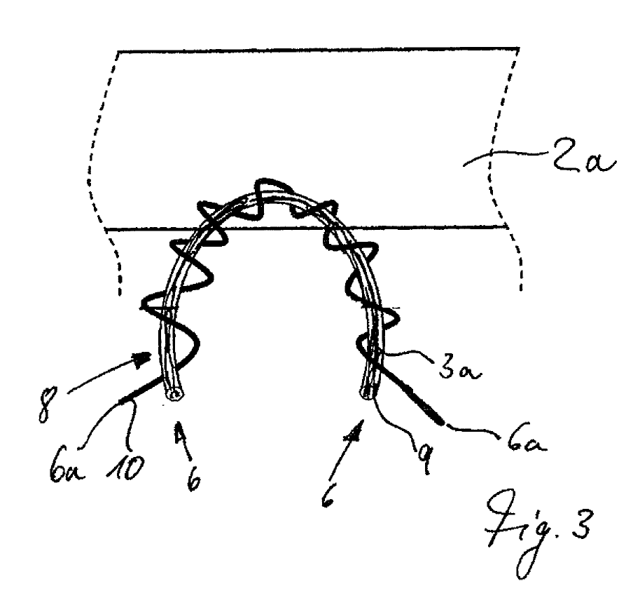

The hooking layer 3 is composed of a special pile yarn 8, which will now be explained in greater detail in conjunction with FIG. 3. The pile yarn 8 has a central multifilament 9, which is composed of a multitude of fine filaments/fibers 3a. A monofilament 10 is wound around the multifilament 9; the composite of the multifilament 9 and monofilament 10 is formed before the production of the tuft of the hooking layer 3 and the composite is tufted into the backing layer 2a. During the tufting, the pile loops composed of the pile yarn 8 are cut so that the hooking layer 3 is embodied in the form of a cut velour layer. This produces the free ends 6 of the pile yarn 8. Since the monofilament 10 is significantly thicker than the fibers 3a of the multifilament 9, the monofilament 10 has a tendency to unwind a little from the multifilament 9. This produces longer free ends 6a of the monofilament 10, which have a greater stiffness than the filaments/fibers 3a of the multifilament 9. When placed onto the underlying support 30, these longer and stiffer ends 6a of the monofilament can favorably hook into the underlying support 30 because they can penetrate farther into the pile of the underlying support 30 due to their higher resistance to buckling. This hooking effect can be increased even more by roughening the monofilament 10 somewhat before the multifilament 9 and the monofilament 10 are combined to produce the pile yarn 8.

In the exemplary embodiment according to FIG. 3, a single monofilament 10 is wound around a multifilament composed of fibers/filaments 3a. Naturally, it is also possible to wind two or more monofilaments 10 around the multifilament 9 composed of filaments/fibers 3a so that the winding of the monofilament(s) 10 around the multifilament 9 is embodied in a manner that resembles a two-threaded or multi-threaded screw (see FIG. 4). Said figure is a very schematic enlarged depiction of a pile yarn 8 in which two monofilaments 10 are wound around the multifilament 9 in a manner that resembles a two-threaded screw. When the multifilament 9 has a multiple winding composed of two or more monofilaments 10, when the tuft loops (pile loops) are cut, this correspondingly produces a multitude of free ends 6a of the monofilaments 10.

According to another embodiment (not shown) two or more monofilaments 10, before being wound around the multifilament 9, can be combined to form a winding multifilament having two or more monofilaments 10; the winding multifilament is then wound around the multifilament 9 as described above.

The filaments/fibers 3a of the multifilament 9 suitably have a fineness of 20 dtex to 80 dtex. The monofilament 10 or monofilaments 10 preferably has/have a fineness of 40 dtex to 800 dtex.

In order to further improve the hooking of the free ends 6a of the monofilaments in the underlying support 30, it is useful to subject the free ends 6a and the free ends 6 in the raised regions 4 to a brief heat treatment so that a partial melting and droplet-shaped thickening of the ends 6a and 6 is produced in some areas. When they penetrate and hook into the underlying support 30, these end thickenings 14 provide an adhesion strength that is increased even further, particularly in that the thickenings do in fact appear droplet-shaped to the naked eye, but have fine hooking irregularities and can therefore achieve an increased hooking to the underlying support 30.

The above-described possible embodiments of the raised regions 4 in comparison to the compacted regions 5, which have been produced in connection with the first alternative according to FIG. 1 naturally also apply to the second exemplary embodiment according to FIGS. 2 through 4.

The method according to the invention will be briefly explained below. In particular, it features the fact that first, the insert mat 1 is provided with a primary backing as a backing layer 2. A decorative layer is tufted into this primary backing or mounted onto its entire surface. Either a velourized needle punched nonwoven (dilour) or a tufted layer with a backing layer 2a is used. With a mounting to the entire surface, it is particularly advisable to use a velourized needle punched nonwoven with the specifications already described above. When a tuft is used as the hooking layer 3, the pile yarn 8 is made of a multifilament 9 composed of fibers/filaments 3a. Preferably, at least one monofilament 10 is wound around the multifilament 9. The tufted pile yarn 8 of the hooking layer 3 is cut to produce free pile ends 6. Then the hooking layer is compressed in some subregions and/or permanently compacted in some subregions, producing the raised regions 4 of the hooking layer 3, which are composed of pile ends 6. After the tufting and cutting of the hooking layer, the compression and/or permanent compaction suitably occurs by means of a heated pressing template (not shown), which is placed onto the hooking layer 3 and through a sufficient pressing power, ensures the formation of compacted and/or compressed regions 5. A compression by means of a heated pressing template is suitable for both the embodiment with a velourized needle punched nonwoven and for the embodiment with a tufted hooking layer made up of pile yarn composed of a multifilament and optionally a monofilament.

The compression can also be carried out in that the regions 5 on the hooking layer 3 that are to be compacted and compressed are pressed down using a pressing template, for example, and then ultrasound is used to bond the pressed-down fibers to one another or possibly to the backing layer 2a.

The monofilaments 10 are suitably roughened before being wound around the multifilament 9 so that after the tufting, the pile loops are cut, producing free ends 6a of the monofilament 10, which have a surface that is roughened and therefore has a greater tendency to produce a hooking action.

It is particularly useful to subject the free ends 6a of the monofilaments 10 and multifilament 9 to a brief partial melting, producing thickenings 14 at the ends, which hook into the underlying support 30, for example a carpeted floor of a passenger vehicle, in a particularly favorable way. Such a brief partial melting can be produced, for example, by means of hot air or by means of a second pressing template that corresponds to the pressing template mentioned above; this second pressing template is heated and is placed onto the hooking layer 3 only until it touches and partially melts the free ends 6, 6a of the multifilaments 9 and monofilament 10.

In particular, the insert mat 1 according to the invention and the method according to the invention feature the fact that the insert mat 1 has a particularly favorable adhesiveness to conventional carpeted floors of passenger vehicles and in addition, is particularly inexpensive to produce since it is possible to eliminate the flocking step. In addition, this insert mat is particularly easy to clean since dirt that becomes embedded during use can be easily removed again from the raised regions, thus making it possible for conventional cleaning methods to restore the original adhesion force that the insert mat had when new.

The method according to the invention particularly excels in how inexpensive it is to carry out. In addition, the stamping step for compacting the hooking layer can be carried out in a very reliable, simple way, making it possible to achieve a low failure rate and low reject rate.

1. An anti-slip insert mat comprising:
a backing layer and a textile hooking layer including a plurality of filaments/fibers wherein the hooking layer has raised regions and compacted regions of lower height, with the raised regions having free ends of the fibers and the compacted regions of the hooking layer being produced by permanent compression of the free ends of the fibers; and during proper use, the hooking layer is oriented toward an underlying passenger vehicle carpet, and is able to hook into the underlying passenger vehicle carpet.

2. The insert mat as recited in claim 1, wherein the hooking layer comprises a tuft with a backing layer into which a pile yarn is tufted, with the raised regions comprising free ends of the pile yarn, the compacted regions being produced by permanent compression of the free ends of the pile yarn, and the pile yarn comprising a multifilament.

3. The insert mat as recited in claim 2, wherein at least one monofilament is wound around the multifilament, with the monofilament being embodied as thicker than fibers/filaments composing the multifilament.

4. The insert mat as recited in claim 1, wherein the hooking layer comprises a velourized needle punched nonwoven.

5. The insert mat as recited in claim 4, wherein the fibers of the hooking layer comprise at least one of the group consisting of PET, PP, PA6, and PA6.6.

6. The insert mat as recited in claim 4, wherein the velourized needle punched nonwoven has a weight per unit area of 200 g/m² to 800 g/m².

7. The insert mat as recited in claim 4, wherein the fibers of the velourized needle punched nonwoven have a fineness of 3.3 dtex to 100 dtex and a cut length of 15 mm to 80 mm.

8. The insert mat as recited in claim 4, wherein the velourized needle punched nonwoven is unclipped or clipped.

9. The insert mat as recited in claim 4, wherein the velourized needle punched nonwoven comprises a mixture of fibers of different materials and/or different finenesses and/or different cut lengths.

10. The insert mat as recited in claim 1, wherein the raised regions form islands.

11. The insert mat as recited in claim 1, wherein the raised regions form a closed linear pattern in the form of a hexagonal honeycomb pattern.

12. The insert mat as recited in claim 1, wherein the raised regions project by approx. 0.5 mm to 3 mm beyond the compacted regions.

13. The insert mat as recited in claim 1, wherein the insert mat comprises a decorative layer and the decorative layer is a velour.

14. The insert mat as recited in claim 3, wherein the permanently compacted regions are produced by thermal compression and the filaments of the multifilament and/or the winding monofilament are fused to one another at least in some regions and/or the filaments and/or the monofilaments are at least partially fused to one another and to the backing layer.

15. The insert mat as recited in claim 3, wherein the thickness of the monofilament is at least two to ten times that of the filaments of the multifilament.

16. The insert mat as recited in claim 1, wherein in regions of the insert mat that are subjected to greater stepping pressure or compressive load during use, the raised regions are positioned closer together than they are in regions that are subjected to less stepping pressure or compressive load.

17. The insert mat as recited in claim 1, wherein in regions that are subjected to greater stepping pressure or compressive load, the degree of compaction is less than it is in regions that are subjected to less stepping pressure or compressive load.

18. The insert mat as recited in claim 1, wherein in regions that are subjected to greater stepping pressure or compressive load, the size in area of the raised regions is greater per unit area than it is in regions that are subjected to less stepping pressure or compressive load.

19. The insert mat as recited in claim 10, wherein the islands are embodied as circular, annular, oval, triangular, polygonal, or irregularly shaped.

20. The insert mat as recited in claim 3, wherein at least two monofilaments are wound around the multifilament in a manner that resembles a two-threaded or multi-threaded screw.

21. The insert mat as recited in claim 3, wherein at least two monofilaments form a winding multifilament that is wound around the multifilament.

22. The insert mat as recited in claim 21, wherein several winding multifilaments are wound around the multifilament.

23. The insert mat as recited in claim 1, wherein a sum of the area percentages of the raised regions is less than or equal to a sum of the area percentages of the compressed and/or compacted regions.

24. The insert mat as recited in claim 1, wherein the raised regions have a greater dimension in a pile direction of an underlying support onto which the insert mat is placed during use than they do transversely to the pile direction of the underlying support.

25. A method for producing an anti-slip insert mat, comprising the following steps:
preparing a backing layer of a hooking layer of an insert mat;
producing a hooking layer on at least one side of the backing layer by tufting a pile yarn or mounting a layer of velourized needle punched nonwoven to an entire surface of the backing layer;
using a pile yarn which is composed of a multifilament, with the tufted pile yarn, and cutting the pile yarn to produce free pile ends, or using a velourized needle punched nonwoven to form the hooking layer; and
compressing and/or permanently compacting subregions of the hooking layer in a manner that produces raised regions of the hooking layer, composed of pile ends of the pile yarn or free fibers of the velourized needle punched nonwoven.

26. The method as recited in claim 25, comprising using a multifilament as the pile yarn, wherein the multifilament has at least one monofilament wound around it, said monofilament being embodied as thicker than a fiber/filament of the multifilament.

27. The method as recited in claim 25, comprising producing the compression in some regions and/or permanent compaction through the application of heat using a heated pressing template.

28. The method as recited in claim 25, comprising producing the compression and/or permanent compaction using ultrasound and pressing with a pressing template.

29. The method as recited in claim 26, wherein the monofilament is roughened.

30. The method as recited in claim 26, comprising subjecting the raised regions, the free ends of the monofilaments and of the multifilament to a brief partial melting, producing thickenings at the ends.

31. The method as recited in claim 30, wherein the brief partial melting is produced using hot air.

32. The method as recited in claim 30, wherein the brief partial melting is produced using a heated plate, which is placed onto the free pile ends or the free ends of the fibers of the velourized needle punched nonwoven, touching them, but not deforming them or only deforming them to an insignificant degree.
